(19) United States
(12) Patent Application Publication
(10) Pub. No.: US 2017/0163471 A1
(43) Pub. Date: Jun. 8, 2017

(54) Collaborative Recovery for an Account Associated with a Social Network

(71) Applicant: Google Inc., Mountain View, CA (US)

(72) Inventor: Wentao Zheng, Jersey City, NJ (US)

(21) Appl. No.: 13/649,907

(22) Filed: Oct. 11, 2012

(51) Int. Cl. G06F 15/16

(52) U.S. Cl. CPC H04L 29/08594

(57) ABSTRACT

A system and method for recovering a user account is disclosed. A challenge module generates questions for recovering an account of a first user. The first user is associated with a social network. A verification module determines that the first user owns the account based on answers of the questions from the first user. A helper module determines a list of users that the first user can ask for help. The first user is connected to the list of users in the social network. The help module notifies the list of users about a recovery request submitted by the first user and receives responses from at least some users in the list of users. The verification module determines that the first user owns the account based on the responses. A recovery module recovers the account for the first user.

### BACKGROUND

The specification relates to verifying that a user in a social network owns an account and recovering the account for the user based on help from the user's associations in the social network.

People manage a lot of accounts on the internet. Sometimes people forget the password of an account or the account gets hacked. Current methods for resetting or recovering the account have limitations. For example, if an account is registered using primary and secondary email addresses, people may recover the account by requesting that a recovery link be transmitted to the primary email address. But this method fails if the primary email address is also hacked. Next, the secondary email address can be easy to lose or can be similarly hacked. In another example, the recovery process can involve answering security questions, but a hacker can often answer the security questions using public information (e.g. what high school the user attended) and the hacker can then reset the security questions.

### SUMMARY

According to one innovative aspect of the subject matter described in this disclosure, a helper module determines a list of users that the first user can ask for help, the first user being connected to the list of users in a social network, notifies the list of users about a recovery request submitted by the first user and receives responses from at least some users in the list of users, the verification module determines that the first user owns the account based on the responses and a recovery module recovers the account for the first user.

In general, another innovative aspect of the subject matter described in this disclosure may be embodied in methods that include determining, with the one or more computing devices, a list of users that the first user can ask for help, the first user being connected to the list of users in the social network, notifying, with the one or more computing devices, the list of users about a recovery request submitted by the first user, receiving responses from at least some users in the list of users, determining, with the one or more computing devices, that the first user owns the account based on the responses and recovering, with the one or more computing devices, the account for the first user. Other aspects include corresponding methods, systems, apparatus, and computer program products.

These and other implementations may each optionally include one or more of the following features. For instance, operations further include determining a communication history between a second user in the social network and the first user, the communication history including at least one of a frequency of recent communications between the first user and the second user and an amount of communications between the first user and the second user over a total time period of interactions, and wherein determining the list of users comprises determining whether to include the second user in the list based on the communication history. Operations further include determining a relationship history between a second user in the social network and the first user, the relationship history including at least a time that the first user has been connected with the second user in the social network, and wherein determining the list of users comprises determining whether to include the second user in the list based on the relationship history. Operations further include determining an overall recovery score from the responses, and wherein determining that the first user owns the account based on the responses comprises determining that the overall recovery score is greater than a threshold recovery score. Operations further include determining a response timeout parameter for each user in the list of users, and wherein receiving the responses from the at least some users in the list of users is based on the response timeout parameter. Operations further include generating a recovery request form for the first user, submitting a completed recovery request by the first user and generating a request identification and a passcode for the submission. Operations further include receiving a correct passcode from the first user, and wherein recovering the account for the first user is based on the correct passcode. Operations further include receiving user activities associated with the first user, and wherein generating the questions for recovering the account of the first user is based on the user activities.

For instance, the features further include determining the list of users by adjusting the list of users according to preferences of the first user. The features further include that notifying the list of users about the recovery request uses a communication means that is different from the communication means used for receiving the responses from the at least some users in the list of users.

The specification advantageously describes a system and method for verifying that a user in a social network owns an account and recovering the account for the user such that the real owner of the account can get back the control of the account.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a block diagram illustrating an example system for verifying that a user in a social network owns an account and recovering the account for the user.

FIG. 2A is a block diagram illustrating example hardware for implementing the functionality of recovering an account for a user in a social network.

FIG. 2B is a block diagram illustrating an example recovery application.

FIG. 3 is a block diagram illustrating an example helper module.

FIG. 4 is a flowchart of an example method for recovering an account for a user in a social network.

FIGS. 5A-5C are flowcharts of an example method for recovering an account for a user in a social network.

FIG. 6A-6D are graphic representations of example user interfaces for recovering an account for a user in a social network.

### DETAILED DESCRIPTION

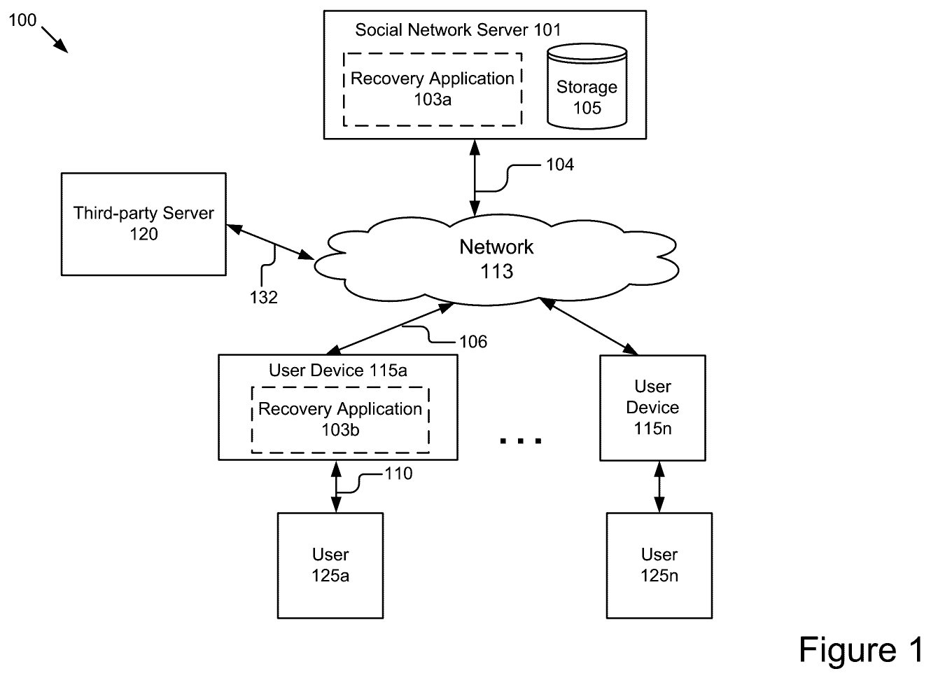

FIG. 1 illustrates a block diagram of a system 100 for verifying that a user in a social network owns an account and recovering the account for the user. The illustrated system 100 for recovering the account for the owner includes user devices 115a, 115n that are accessed by users 125a, 125n, a social network server 101 and a third-party server 120. In the illustrated example, these entities are communicatively coupled via a network 113. In FIG. 1 and the remaining figures, a letter after a reference number, for example, “115a” is a reference to the element having that particular reference number. A reference number in the text without a following letter, for example, “115” is a general reference to different instances of the element bearing that reference number. Although only two devices are illustrated, an arbitrary number of user devices 115n is available to an arbitrary number of users 125n.

In some instances, the recovery application 103a is operable on the social network server 101, which is coupled to the network 113 via signal line 104. Although only one social network server 101 is shown, persons of ordinary skill in the art will recognize that multiple servers can be present. The social network server 101 can include software for generating a social network. The social network includes relationships that are defined in a social graph. The social graph is a mapping of users in a social network and how they are related to each other.

The storage device 105 is a non-volatile memory device or similar persistent storage media for storing instructions and/or data used for verifying that a user in a social network owns an account and recovering the account for the user. The storage device 105 is communicatively coupled to the recovery application 103a.

In other instances, the recovery application 103b is stored on a user device 115a, which is connected to the network 113 via signal line 106. In one example, the recovery application 103b is a thin-client application that includes part of the recovery application 103 on the user device 115a and part of the recovery application 103 on the social network server 101 to verify that a user in a social network owns an account and recover the account for the user.

The user 125a interacts with the user device 115a via signal line 110. The user device 115a, 115n can be a computing device, for example, a laptop computer, a desktop computer, a tablet computer, a mobile telephone, a personal digital assistant (PDA), a mobile email device, a portable game player, a portable music player, a television with one or more processors embedded therein or coupled thereto or any other electronic device capable of accessing a network.

The network 113 is a conventional type, wired or wireless, and has arbitrary number of configurations, for example, as a star configuration, token ring configuration or other configurations known to those skilled in the art. Furthermore, the network 113 includes a local area network (LAN), a wide area network (WAN) (e.g., the Internet), and/or other interconnected data paths across which multiple devices can communicate. In yet other instances, the network 113 is a peer-to-peer network. The network 113 is also coupled to or includes portions of a telecommunications network for sending data in a variety of different communication protocols. In some instances, the network 113 includes Bluetooth communication networks or a cellular communications network for sending and receiving data, for example, via short messaging service (SMS), multimedia messaging service (MMS), hypertext transfer protocol (HTTP), direct data connection, WAP, email, etc.

The recovery application 103 verifies that a first user in a social network owns an account and recovers the account for the first user. For example, if one of Mary's accounts associated with the social network was hacked or Mary is having difficulty accessing the account, the recovery application 103 gets the account back for Mary after verifying that Mary is the real owner of the account.

In some instances, the recovery application 103 questions the first user in a social network about the user activities associated with an account. If the first user answers the questions correctly, the recovery application 103 verifies that the first user owns the account. Continuing with the above example, the recovery application 103 may ask Mary about what groups she has joined, who else is a member of her groups and with whom she talked to the most in the last seven days and determines the correctness of her answers.

Once the recovery application 103 determines that the first user has passed the verification using the questions, the recovery application 103 determines a list of other users that the first user can ask for help (e.g., a help list) and sends a notification to each user in the help list about a recovery request from the first user. The first user is connected to the list of users in the social network. The recovery application 103 receives responses from some users in the help list and determines an overall recovery score from the responses. If the overall recovery score exceeds a threshold, the recovery application 103 determines that the first user actually owns the account and recovers the account for the first user. The threshold is designed so that the first user can recover the account even when only a subset of the users in the help list respond. For the above example, the recovery application 103 sends Mary's request for recovering the account to Andrew, Alan and Bill. Andrew and Bill contacted Mary to confirm that Mary made the recovery request. The recovery application 103 receives the positive responses from Andrew and Bill and generates an overall recovery score for the responses. The recovery application 103 determines whether to recover the account for Mary based on the overall recovery score.

In some instances, the recovery application 103 adds a second user to the help list of the first user because the second user frequently interacts with the first user in the social network. In some other instances, the recovery application 103 adds the second user to the help list because a relationship between the first user and the second user has been established for a long time. Continuing with the example above, Andrew, Alan and Bill are added to the help list of Mary because Andrew has been friends with Mary since Mary first registered with the social network, Alan and Mary share many common interests and always have some topics to talk, and Bill continuously communicates with Mary recently for her expertise.

In some instances, the recovery application 103 is used to recover an account that is run by a third-party server 120. For example, the third-party server 120 manages an account for a user (e.g. the account is related to electronic messaging, banking, news, shopping, etc.) that is also registered with the social network server 101. When a user requests account recovery services from the third-party server 120, the third-party server 120 redirects the user to the recovery application 103. Once the user completes the recovery steps, the third-party server 120 provides the user with access to the account.

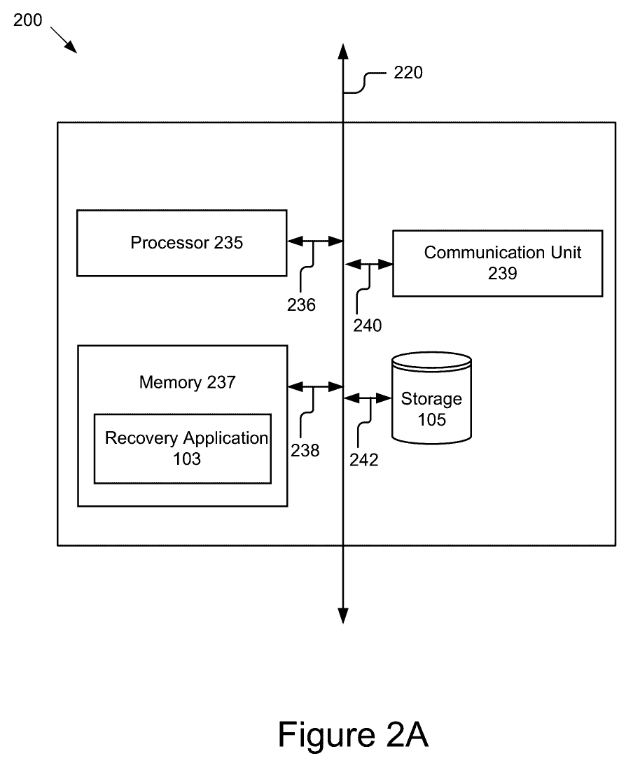

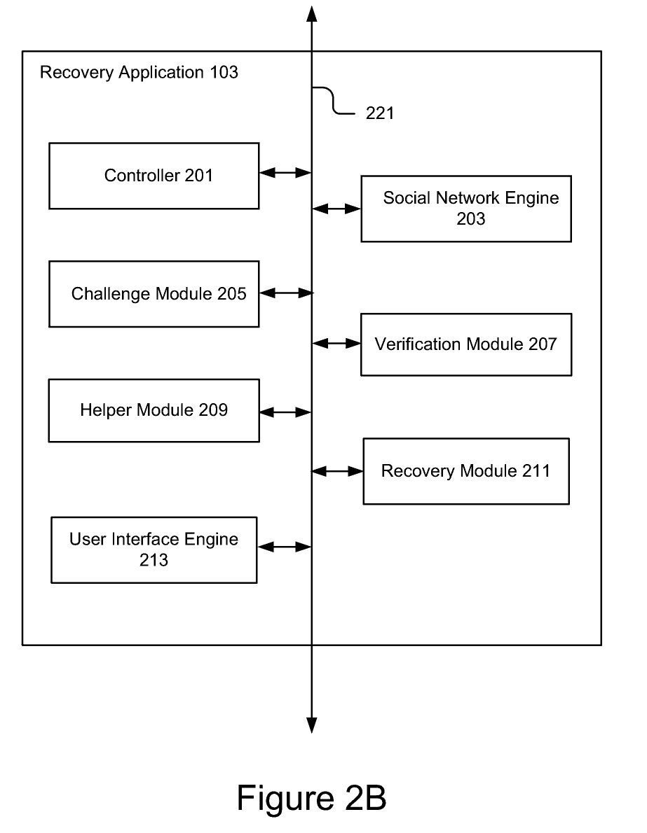

Referring now to FIG. 2A, example hardware implementing the functionality of verifying that a user in a social network owns an account and recovering the account for the user is shown in more detail. FIG. 2A is a block diagram of a computing device 200 that includes a processor 235, memory 237, storage 105 and a communication unit 239. In some instances, the computing device 200 is the social network server 101. In other instances, the computing device 200 is the user device 115a.

The processor 235 includes some or all of an arithmetic logic unit, a microprocessor, a general purpose controller or some other processor array to perform computations and provide electronic display signals to a display device. The processor 235 is coupled to the bus 220 for communication with the other components via signal line 236. Processor 235 processes data signals and may include various computing architectures including a complex instruction set computer (CISC) architecture, a reduced instruction set computer (RISC) architecture, or an architecture implementing a combination of instruction sets. Although only a single processor is shown in FIG. 2A, multiple processors are included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible.

The memory 237 stores instructions and/or data that may be executed by processor 235. The memory 237 is coupled to the bus 220 for communication with the other components via signal line 238. The instructions and/or data may include code for performing any and/or all of the techniques described herein. The memory 237 may be a dynamic random access memory (DRAM) device, a static random access memory (SRAM) device, flash memory or some other memory device known in the art. In some instances, the memory 237 also includes a non-volatile memory or similar permanent storage device and media, for example, a hard disk drive, a floppy disk drive, a CD-ROM device, a DVD-ROM device, a DVD-RAM device, a DVD-RW device, a flash memory device, or some other mass storage device known in the art for storing information on a more permanent basis.

The communication unit 239 transmits and receives data to and from the computing device 200. The communication unit 239 is coupled to the bus 220 via signal line 240. In some instances, the communication unit 239 includes a port for direct physical connection to the network 113 or to another communication channel. For example, the communication unit 239 includes a USB, SD, CAT-5 or similar port for wired communication with the user device 115. In other instances, the communication unit 239 includes a wireless transceiver for exchanging data with the user device 115 or any other communication channel using one or more wireless communication methods, such as IEEE 802.11, IEEE 802.16, BLUETOOTH® or another suitable wireless communication method.

In other instances, the communication unit 239 includes a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In other instances, the communication unit 239 includes a wired port and a wireless transceiver. The communication unit 239 also provides other conventional connections to the network for distribution of files and/or media objects using standard network protocols such as TCP/IP, HTTP, HTTPS and SMTP as will be understood to those skilled in the art.

Referring now to FIG. 2B, an example recovery application 103 is shown in more detail. In some instances, the recovery application 103 includes a controller 201, a social network engine 203, a challenge module 205, a verification module 207, a helper module 209, a recovery module 211 and a user interface engine 213 that communicate over the software communication mechanism 221. Software communication mechanism 221 may be an object bus (such as CORBA), direct socket communication (such as TCP/IP sockets) among software modules, remote procedure calls, UDP broadcasts and receipts, HTTP connections, function or procedure calls, etc. Further, any or all of the communication could be secure (SSH, HTTPS, etc.). The software communication can be implemented on any underlying hardware, such as a network, the Internet, a bus 220, a combination thereof, etc.

The controller 201 can be software including routines for receiving data and transmitting the data to an appropriate component. In some instances, the controller 201 can be a set of instructions executable by the processor 235 to provide the functionality described below for receiving and transmitting the data. In other instances, the controller 201 can be stored in the memory 237 of the computing device 200 and can be accessible and executable by the processor 235. The controller 201 may be adapted for cooperation and communication with the processor 235 and other components of the computing device 200 via the software communication mechanism 221.

In some instances, the controller 201 receives data via the communication unit 239 and transmits the data to the appropriate module of the recovery application 103. For example, the controller 201 receives responses from a list of users to a request of recovering an account for a first user via the communication unit 239 and transmits the users' responses to the verification module 207 for verifying whether the first user owns the account. In other instances, the controller 201 receives data (e.g., user interactions, user profiles, etc.) from the social network engine 203 and transmits the data to an appropriate component. In other instances, the controller 201 receives data from a user interface generated by the user interface engine 213 and transmits the data to an appropriate component. In one example, the controller 201 receives answers for a set of questions from a user via a user interface and sends the answers to the verification module 207. In another example, the controller 201 receives a correct passcode from a user via a user interface and passes the passcode to the recovery module 211.

The social network engine 203 can be software including routines for generating and managing a social network. In some instances, the social network engine 203 can be a set of instructions executable by the processor 235 to provide the functionality described below for generating and managing the social network. In other instances, the social network engine 203 can be stored in the memory 237 of the computing device 200 and can be accessible and executable by the processor 235. The social network engine 203 may be adapted for cooperation and communication with the processor 235 and other components of the computing device 200 via the software communication mechanism 221.

In some instances, the social network engine 203 manages registration of users and creation of a user profile. The social network engine 203 also manages the association of different actions with the user profile including the publication of posts (e.g. text, links or media) to a selected audience, the publication of comments, indications of acknowledgement (e.g. approval, disapproval, thumbs up, thumbs down, like, dislike. etc.), uploading of media (e.g. photos, videos, etc.), check-ins to different locations and other actions associated with a social network.

In some instances, the social network engine 203 creates a social graph and an interest graph that are stored in the storage 105. The social graph includes the relationship between people in a social network and the interest graph includes a mapping of relationships between interests associated with the users. For the social graph, when a first user follows a second user, the relationship is a first-degree relationship. If the second user follows a third user that the first user does not follow, the first user has a second-degree relationship with the third user. This relationship can also be described in terms of social affinity. For example, the social network engine 203 generates a higher social affinity score for the first-degree relationship between the first user and the second user than the second-degree relationship between the first user and the second user. The first user has a closer social affinity to the second user than the third user. The social network engine 203 transmits the data (e.g., user activity data, social affinity information, social graph information, etc.) to the controller 201 for processing and organizing with other data sources. For the interest graph, one example would be that user A and user B both share an interest in European queens, and user B and user C both share an interest in surfing.

The challenge module 205 can be software including routines for generating questions that are used for recovering an account of a user and receiving answers to the questions from the user. In some instances, the challenge module 205 can be a set of instructions executable by the processor 235 to provide the functionality described below for generating the questions for the user and receiving the answers to the questions from the user. In other instances, the challenge module 205 can be stored in the memory 237 of the computing device 200 and can be accessible and executable by the processor 235. The challenge module 205 may be adapted for cooperation and communication with the processor 235 and other components of the computing device 200 via the software communication mechanism 221.

In some instances, the challenge module 205 receives user activities associated with an account of a user in a social network via the controller 201 and generates questions for recovering the account of the user based on the user activities. In some instances, the challenge module 205 processes the user activities to obtain user activity statistics and generates the questions based on the user activity statistics. For example, the challenge module 205 generates questions about with whom the user talked most in the last week (e.g. based on electronic messages, commenting on posts in the social network, etc.) and what is the main topic they talked, how long on average the user spent on the social network in the past 3 days, how many photos the user shared in the social network in the last 24 hours, which photo that the user shared in the last 24 hours got the largest number of positive acknowledgements from other users, etc. In some instances, the challenge module 205 stores the user activity statistics in the storage 105.

In other instances, the challenge module 205 generates the questions based on pre-defined rules about the user activities. For example, the challenge module 205 asks the user to list the groups that the user has joined, names of a certain number of other members in the groups, the name of a celebrity that the user follows, etc. In some instances, the challenge module 205 may also ask the user about the last activity that the user remembered to perform before the user failed to log into the social network with the account. This information is particularly useful for adjusting a verification parameter by the verification module 207 as described in more detail below.

In some instances, the challenge module 205 generates questions as open ended and provides the verification module 207 with matching answers. For example, the challenge module 205 asks the user to name another member of the social network that the user frequently interacts with. In some instances, because open ended questions are harder to answer the challenge module 205 provides the verification module 207 with a list of the top five social network members that the user frequently interacts with. In some other instances, the challenge module 205 generates a question and provides the user with multiple answers, where a subset of the answers are correct. For example, the challenge module 205 asks the user for a list of groups that the user has joined and provides three incorrect answers and one correct answer.

In some instances, the challenge module 205 communicates with the user interface engine 213 to generate a user interface for rendering the questions to the user and receiving the answers of the questions from the user. In other instances, the challenge module 205 interacts with the controller 201 to send the questions to the user and receives the answers from the user through electronic messaging (e.g. an email, an instant message), a notification in the social network or other communication means. In some other instances, the challenge module 205 uses an arbitrary combination of a user interface, an email, an instant message and other communication means to send the questions to the user and receive the answers from the user. In some instances, the challenge module 205 stores the questions and the user's answers of the questions in the storage 105. In other instances, the challenge module 205 also transmits the answers to the verification module 207.

The verification module 207 can be software including routines for determining whether a user in a social network owns an account. In some instances, the verification module 207 can be a set of instructions executable by the processor 235 to provide the functionality described below for determining whether the user in the social network owns the account. In other instances, the verification module 207 can be stored in the memory 237 of the computing device 200 and can be accessible and executable by the processor 235. The verification module 207 may be adapted for cooperation and communication with the processor 235 and other components of the computing device 200 via the software communication mechanism 221.

In some instances, the verification module 207 communicates with the challenge module 205 and the helper module 209 to perform a two-step verification for determining whether a user in a social network owns an account.

In some instances, the verification module 207 first communicates with the challenge module 205 to verify whether the user owns the account. The challenge module 205 generates questions for recovering the account of the user and sends the questions to the user. In some instances, verification module 207 receives the correct answers from the challenge module 205, the answers provided by the user from the controller 201 and determines whether the answers are correct by comparing the user-provided answers to answers provided by the challenge module 205. In some instances, the correct answers are stored in the storage 105 and the verification module 207 retrieves the correct answers from the storage 105 and compares them to the user-provided answers.

In some instances, the verification module 207 determines that the answers are correct if each user-provided answer is consistent with the correct answers. In other instances, the verification module 207 determines that the answers are correct if at least N percent of the user-provided answers are consistent with the correct answers. In some instances, the verification module 207 specifies a fixed value for N, e.g., N=70. In other instances, the verification module 207 adjusts the value for N based on time information inferred from the answers.

For example, Molly uploaded a photo to share with her friends in a social network on Tuesday night. On Saturday morning, Molly discovered that she cannot log into the social network with her account information (e.g., Molly went hiking in an isolated mountain with no connection to the social network from Wednesday to Friday and did not discover the problem until Saturday). Molly accessed the system 100 to initiate a recovery procedure for her account. The challenge module 205 generates questions about Molly's activities in the social network associated with her account. Molly receives the questions and answers the questions. The verification module 207 receives Molly's answers passed by the controller 201. In particular, when Molly is asked: “What is the last activity that you remember performing with your account?” Her answer is that she uploaded a photo on Tuesday night. The verification module 207 compares this time stamp (e.g., Tuesday night) with the current time (e.g., Saturday morning) and determines that three days have elapsed. Since the time elapsed is measured based on the last activity that Molly remembered doing with her account, other activities that Molly remembered must occur at least three days ago. Considering that Molly's answers to the questions of activities that occurred at least three days ago may be less accurate than if the time was more recent, the verification module 207 determines to lower the value N, e.g., N=60. As a result, even if Molly wrongly answers some questions because of a vague memory about what occurred, a lower N may compensate for the time difference and reduce the possibility that Molly fails this verification step based on questions.

If the verification module 207 determines that the answers from the user are correct, the verification module 207 determines that the user has passed a first verification step. The verification module 207 then communicates with the helper module 209 to perform a second verification step to determine whether the user owns the account. In some instances, the verification module 207 receives an overall recovery score from the helper module 209 and determines whether the overall recovery score exceeds a threshold recovery score. In some instances, the verification module 207 specifies a fixed threshold recovery score. If the overall recovery score exceeds the threshold recovery score, the verification module 207 determines that the user has passed the verifications (e.g., the first and second verification steps) and signals the recovery module 211 to recover the account for the user. In some instances, the verification module 207 also notifies the user that the user's recovery request for recovering the account has been approved and the recovery for the account is initiated.

The helper module 209 can be software including routines for getting help from a list of users for recovering an account of a first user. In some instances, the helper module 209 can be a set of instructions executable by the processor 235 to provide the functionality described below for getting help from the list of users for recovering the account of the first user. In other instances, the helper module 209 can be stored in the memory 237 of the computing device 200 and can be accessible and executable by the processor 235. The helper module 209 can be adapted for cooperation and communication with the processor 235 and other components of the computing device 200 via the software communication mechanism 221.

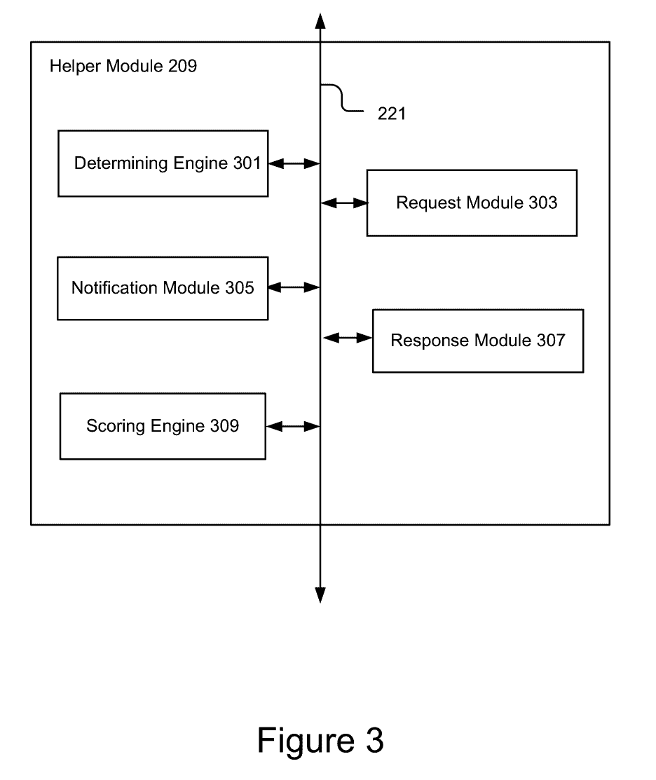

Referring now to FIG. 3, an example helper module 209 is shown in more detail. In some instances, the helper module 209 includes a determining engine 301, a request module 303, a notification module 305, a response module 307 and a scoring engine 309.

The determining engine 301 can be software including routines for determining the list of users that the first user can ask for help (referred hereafter as a “help list”). The first user is connected to each user in the help list in a social network. The determining engine 301 determines how many users and which users should be included in the help list. In some instances, the determining engine 301 determines that the number of users in the help list should be significant compared to a total number of users that the first user is connected to in the social network. For example, if Tom is connected to eight users in a social network, the determining engine 301 determines that two users in Tom's help list would be significant. However, if Tom is connected to a total of 49 users in the social network, the determining engine 301 determines to include 10 users instead of two users.

The determining engine 301 determines which users that the first user has a connection with in the social network should be included in the help list of the first user. In some instances, the determining engine 301 determines a communication history between a second user in the social network and the first user and determines whether to include the second user in the help list based on the communication history. In some instances, the communication history includes a frequency and a recency of communications between the first user and the second user. If the first and second users frequently interact and the interactions are recent, the determining engine 301 includes the second user in the help list of the first user. For example, Alice (e.g., a buyer) and Tom (e.g., a real estate agent) are working together to buy a house for Alice. Because Alice and Tom have been talking at least once a day in a social network for a while, the determining engine 301 determines to put Alice in Tom's help list.

In other instances, the communication history includes an amount of communications between the first user and the second user over a total time period of interactions. The determining engine 301 includes the second user in the help list of the first user if a large amount of communications have accumulated between the first and second users during the time period. For example, Bella and Molly are coworkers that communicate in the social network to make a weekly plan for their store (e.g., product inventory, product promotion, product prices, etc.) since they connected with each other in the social network 6 months ago. As a result, the determining engine 301 determines to include Bella in Molly's help list. The determining engine 301 also includes Alan in Molly's help list because Alan and Molly both follow the other user and share many common interests (e.g., taking photos, reading books, etc.).

In other instances, the determining engine 301 determines a relationship history between the first user and the second user and determines whether to include the second user in the help list of the first user based on the relationship history. In some instances, the relationship history includes a length of time that the first user has been connected with the second user in the social network. The determining engine 301 determines to include the second user in the help list of the first user if the two users have been connected for a long time. For example, the determining engine 301 includes Andrew in the help list of Mary because Andrew has been friends with Mary since Mary first registered with the social network.

In other instances, the relationship history also includes a social affinity between the first user and the second user. The determining engine 301 uses the social affinity to determine whether to include the second user in the help list of the first user. For example, if both Andrew and Andy often talk to Mary, the determining engine 301 may put Andrew instead of Andy in the help list of Mary because Mary has a higher social affinity score with Andrew than with Andy (e.g., Andrew and Mary follows each other. Mary follows Andy while Andy does not follow Mary).

In other instances, the determining engine 301 interacts with the first user to adjust the help list based on preferences specified by the first user. For example, the determining engine 301 communicates with the user interface engine 213 to generate a user interface for presenting a help list for Molly. Molly does not want Betty in her list because Molly knows that Betty is busy in her wedding preparation and Betty may not be able to help her in the short time needed to help Molly recover the account. Molly removes Betty from her help list via the user interface. In some instances, the determining engine 301 also interacts with the first user to determine whether a second user that the first user intends to add to the help list should be included in the help list. Continuing with the above example, Molly wants to add Tony in her help list to replace Betty. The determining engine 301 checks the communication history and the relationship history between Molly and Tony and determines whether to include Tony in her help list. If the determining engine 301 determines not to include Tony in Molly's help list, the determining engine 301 would suggest another user or ask Molly to input another user via the user interface. In some instances, the determining engine 301 stores the help list for the first user in the storage 105.

The request module 303 can be software including routines for generating a recovery request and related information. In some instances, the request module 303 generates a recovery request form for the first user. The request module 303 communicates with the user interface engine 213 to generate a user interface to present the recovery request form to the first user. The first user fills the recovery request form and submits a recovery request (e.g., the completed recovery request form) via the user interface. The request module 303 generates a request identifier (ID) and a passcode for the submission. In some instances, the request ID, which identifies the first user's recovery request, is visible to the first user and each user in the help list of the first user. The passcode that is used for recovering the account for the first user is only visible to the first user. In some instances, the request module 303 stores the request ID and passcode in the storage 105. In other instances, the request module 303 provides the request ID and passcode to the first user. In some other instances, the request module 303 also transmits the request ID and the recovery request to the notification module 305.

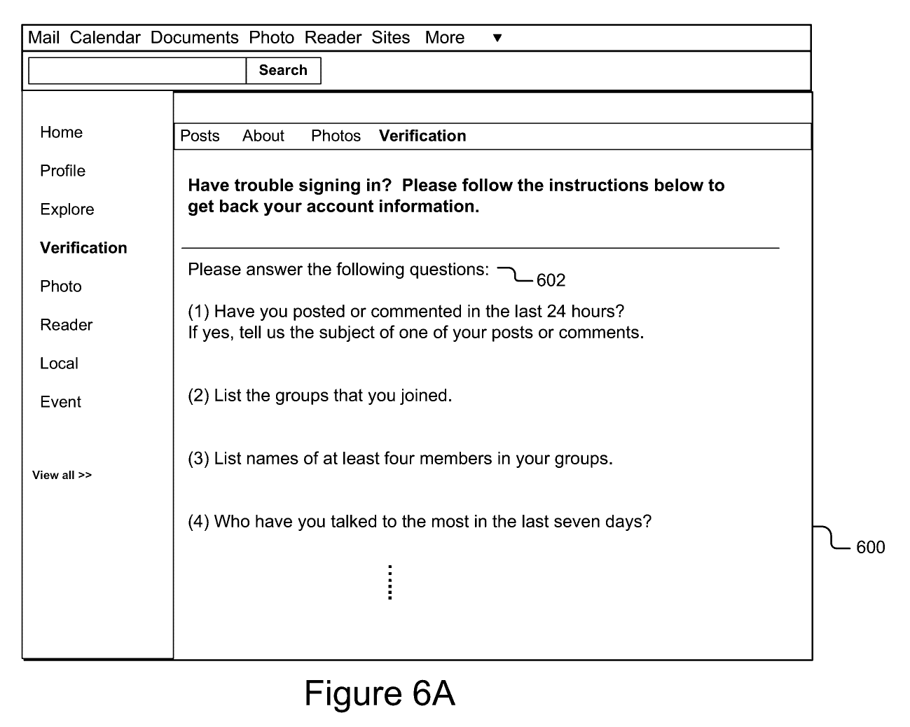

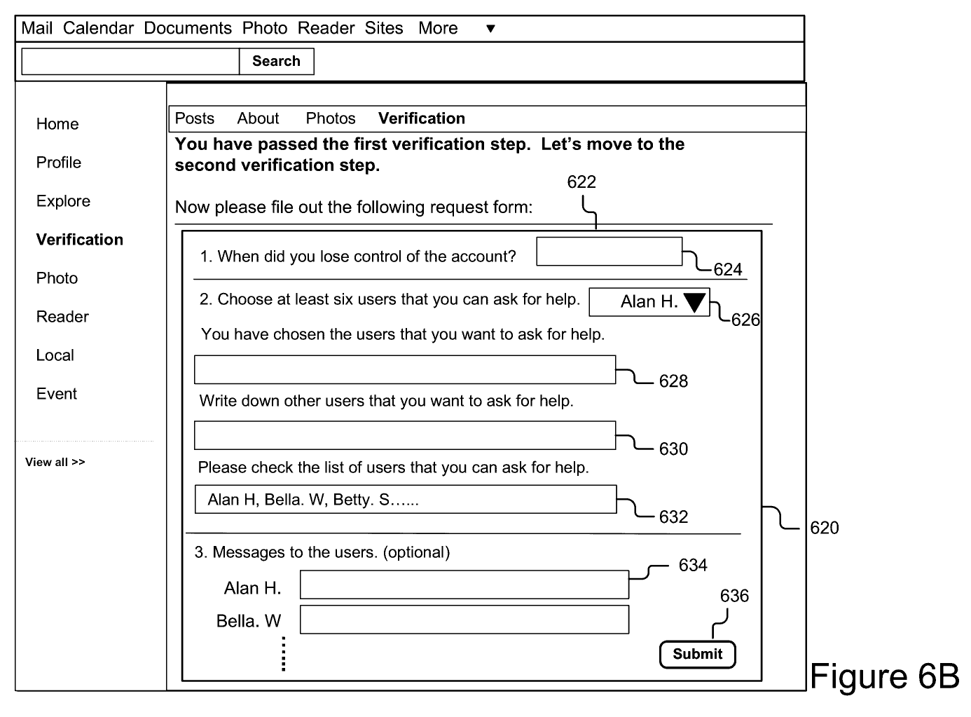

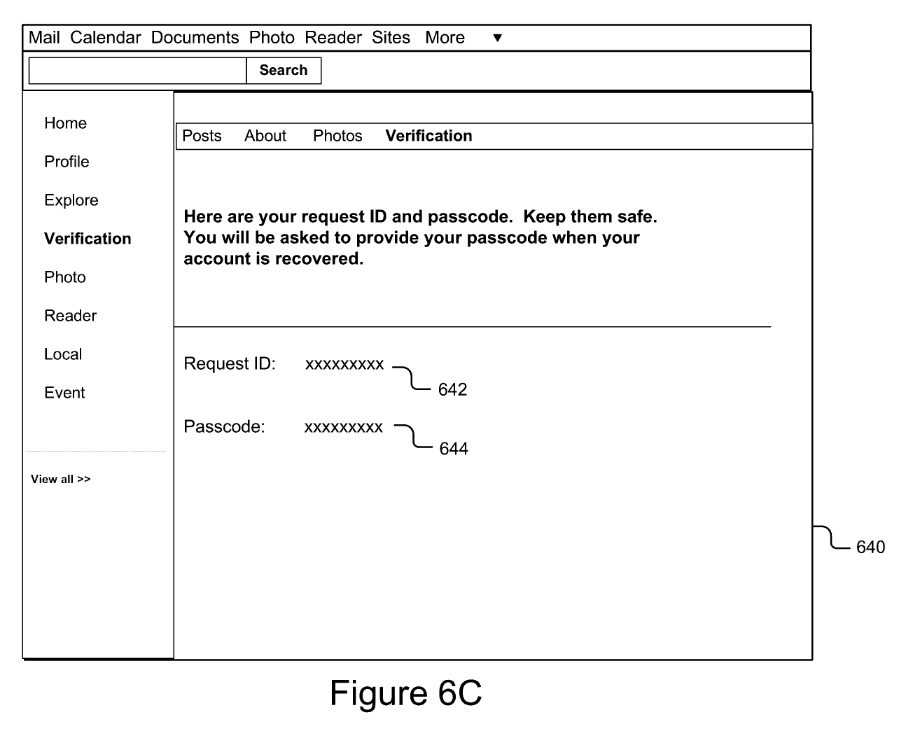

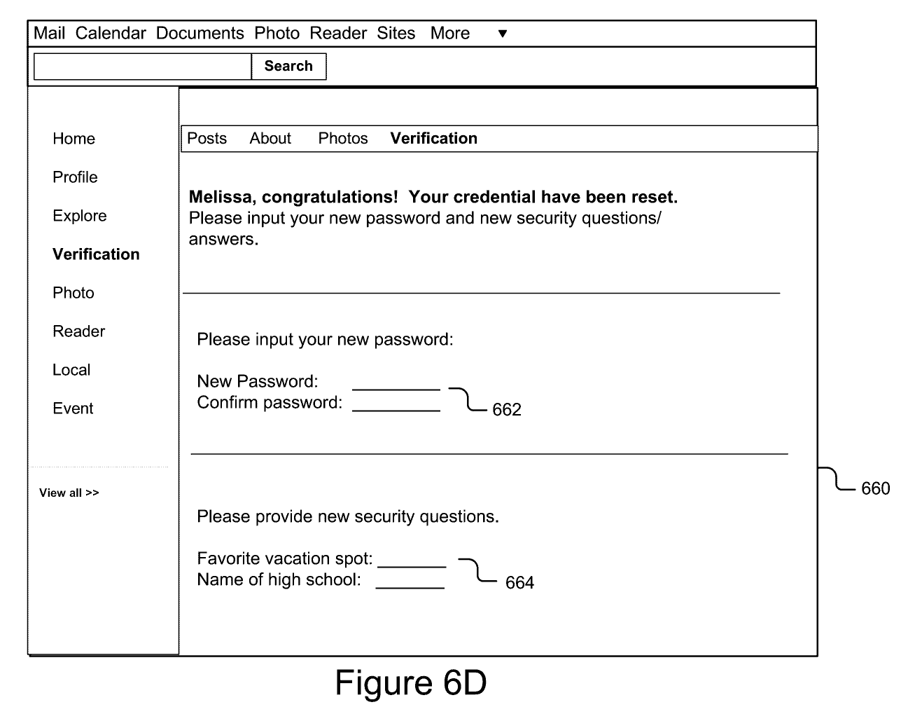

In some instances, the request module 303 generates a recovery request to include information about when the first user lost control of the account. For example, the request module 303 includes the question “when did you lose control of the account” in the recovery request form and receives an answer from the first user. In other instances, the request module 303 generates the recovery request that also includes the first user's help list. In some instances, the request module 303 receives the help list from the determining engine 301. In other instances, the request module 303 receives instructions and preferences from the first user and adjusts the help list received from the determining engine 301 based on the instructions and preferences. For example, the determining engine 301 selects Bella as one of the friends that may help Molly to recover her account because Bella and Molly recently communicated frequently in a social network. But since most of the recent conversions between Bella and Molly were arguments about a business deal, Molly prefers not to bother Bella with a recovery request for her account. The request module 303 receives Molly's preference and removes Bella from the help list received from the determining engine 301. In some other instances, the request module 303 generates the recovery request that may include messages that the first user wants to deliver to the users in the help list. In some instances, the recovery request includes a unified message that the first user wants to deliver to each user in the list of users. For example, the recovery request includes a “Hello” message from Tom to his friends. In other instances, the recovery request includes messages that the first user wants to deliver to each individual user in the help list. An example recovery request form is shown in more detail below with reference to FIG. 6B.

The notification module 305 can be software including routines for notifying each user in the help list for the first user about the recovery request submitted by the first user. In some instances, the notification module 305 sends a notification to each user in the help list by sending an email, sending an instant message, sending a text message, notifying the users in a stream of a social network or displaying a direct message in a notification box. In some instances, the notification module 305 notifies each user in the help list using the same mode of communication (e.g., all users receive text messages). In other instances, the notification module 305 receives instructions from the first user and notifies a second user in the help list using a mode of communication that is specified in the instructions. For example, the notification module 305 sends an email to Alan to notify him of Molly's recovery request because Molly knows that Alan checks his emails regularly.

In some instances, the notification module 305 receives the recovery request and the related information from the request module 303 and generates a notification based on the received information. For example, the notification module 305 sends a notification that includes a time that the first user lost control of the account, messages from the first user to each user in the help list and a request ID to each user in the help list.

In some instances, the notification module 305 includes a time limit for responding in the notification that is transmitted to each user in the help list. The notification module 305 determines a response timeout parameter for each user in the help list and notifies each user to respond within the time interval specified by the response timeout parameter. In some instances, the notification module 305 specifies a response timeout parameter for a second user in the help list based on instructions received from the first user. For example, the notification module 305 notifies Alice of Tom's recovery request and asks Alice to respond the notification within 12 hours based on Tom's instructions. Tom chooses this 12-hour response timeout parameter because he knows that Alice cannot handle private matters during work hours. In some instances, the timing is otherwise based on a default setting or a level of activity of the user in the social network. For example, the notification module 305 determines based on information received from the social network engine 203 that the second user logs-in to the social network five times a day. This user is assigned a shorter response time than a user that only logs-in once a week.

In other instances, the notification module 305 also provides different ways for each user from the help list to respond to the notification. For example, the notification module 305 transmits a notification that includes a link that the user clicks on to respond to the request. In some instances, the notification includes instructions for how the user can respond to the notification. For example, the notification module 305 instructs the second user to respond to the notification using a mode of communication that is different from the communication means used for the second user receiving the notification. Continuing with the example above, when the notification module 305 puts a notification in a stream in a social network and notifies Alice that Tom sent a recovery request for his account, the notification module 305 also instructs Alice in the notification that she should respond the notification by an email, a text message or other mode of communication that differs from displaying a notification in a stream. In some other instances, the notification module 305 notifies the second user with a first mode of communication and instructs the second user to respond the notification by contacting the first user via a second mode of communication to confirm that the first user made the recovery request identified by the request ID and replying the notification via a third mode of communication to confirm that the second user has contacted with the first user and verified the recovery request of the first user.

In some instances, the notification module 305 stores notifications associated with each user in the help list in the storage 105. In other instances, the notification module 305 also signals to the response module 307 that the notifications have been sent to each user in the help list.

The response module 307 can be software including routines for communicating with the notification module 305 to receive responses from at least some users in the help list. In some instances, responsive to receiving a signal from the notification module 305 indicating that notifications have been sent to each user in the help list, the response module 307 starts to collect responses to the notification from each user in the help list. In some instances, the response module 307 receives a response timeout parameter for each user in the help list from the notification module 305 and waits for receiving responses from each user in the help list until the time for responding expires for each user. The response module 307 passes the responses received from at least some users in the help list to the scoring engine 309. In some instances, the response module 307 also stores the responses in the storage 105.

The scoring engine 309 can be software including routines for generating an overall recovery score from responses received via the response module 307. In some instances, the scoring engine 309 determines a ratio between how many users in the help list responded and a total number of users in the help list and uses the ratio as an overall recovery score. For example, if 3 out of 4 users in Tom's help list responded to Tom's recovery request, the scoring engine 309 determines that the overall recovery score is 3/4=0.75.

In other instances, the scoring engine 309 generates a recovery score for each response and determines an overall recovery score from the individual recovery scores. In some instances, the scoring engine 309 determines a recovery score for a response from a second user in the help list based on the communication history and the relationship history between the first user and the second user. Either higher volume of communications or a closer relationship between the first user and the second user contributes more to the recovery score for the response from the second user. For example, when Jamie and Jerry respond to Bill's recovery request, the scoring engine 309 may determine a higher recovery score for Jamie's response (e.g., 1) than Jerry's response (e.g., 0.8) because Jamie has been friends with Bill for six years while Jerry became a good friend of Bill two years ago. In other instances, the scoring engine 309 also determines whether the response from the second user is positive and correspondingly adjusts the recovery score for the response. For the above example, the scoring engine 309 assigns 1 to Jamie's response and −1 to Jerry's response because Jamie confirms that Bill is the owner of the account but Jerry thinks that Bill does not own the account.

In some instances, the scoring engine 309 determines an overall score by averaging the recovery scores from each response (assuming a zero score for each user who did not respond). Continuing with the above example, Alice, Bella, Jamie and Jerry are on the help list of Bill. Alice and Bella did not respond to Bill within a time interval and get zero recovery scores. The scoring engine 309 determines a recovery score of 1×1=1 for Jamie's response and a recovery score of 0.8×(−1)=−0.8 for Jerry's response. The scoring engine 309 determines an overall score of (0+0+1−0.8)/4=0.05. In some instances, the scoring engine 309 sends the overall recovery score to the verification module 207 to determine whether the first user owns the account.

In some instances, if the scoring engine 309 determines that the overall score is below the threshold, the notification module 305 instructs the user interface engine 213 to generate graphical data for notifying the first user that the recovery attempt failed. In some other instances, the notification module 305 instructs the user interface engine 213 to send a message to the user associated with the account using a mode of communication specified during registration to inform the user that someone is trying to recover the account. This is because a failed recovery attempt could be one that was initiated by a hacker.

Referring back to FIG. 2B, the recovery module 211 can be software including routines for recovering an account for a user. In some instances, the recovery module 211 can be a set of instructions executable by the processor 235 to provide the functionality described below for recovering the account for the user. In other instances, the recovery module 211 can be stored in the memory 237 of the computing device 200 and can be accessible and executable by the processor 235. The recovery module 211 can be adapted for cooperation and communication with the processor 235 and other components of the computing device 200 via the software communication mechanism 221.

In some instances, the recovery module 211 recovers the account for the first user in response to receiving a signal from the verification module 207. The signal indicates that the recovery request of the first user for recovering the account has been approved. In some instances, the recovery module 211 also receives a passcode from the first user, determines that the passcode is correct (e.g., by comparing with the passcode with the passcode that is stored in the storage 105), recovers the account corresponding to the request ID based on the correct passcode and sends the account information to the first user. The recovery for the account is described in more detail below with reference to FIG. 6D.

The user interface engine 213 can be software including routines for generating a user interface that displays user profiles (e.g. posts, name, education, working history), user inputs and a social network (e.g. posts, photos, videos, comments). In some instances, the user interface engine 213 can be a set of instructions executable by the processor 235 to provide the functionality described below for generating the user interface. In other instances, the user interface engine 213 can be stored in the memory 237 of the computing device 200 and can be accessible and executable by the processor 235. The user interface engine 213 can be adapted for cooperation and communication with the processor 235 and other components of the computing device 200 via the software communication mechanism 221.

In some instances, the user interface engine 213 generates graphical data for displaying questions generated by the challenge module 205. In other instances, the user interface engine 213 generates a user interface to receive user inputs. In one example, the user interface engine 213 generates a user interface to receive answers from a user to the questions that are used to recover an account for the user. In another example, the user interface engine 213 generates a user interface to receive a correct passcode from a user to recover the account for the user.

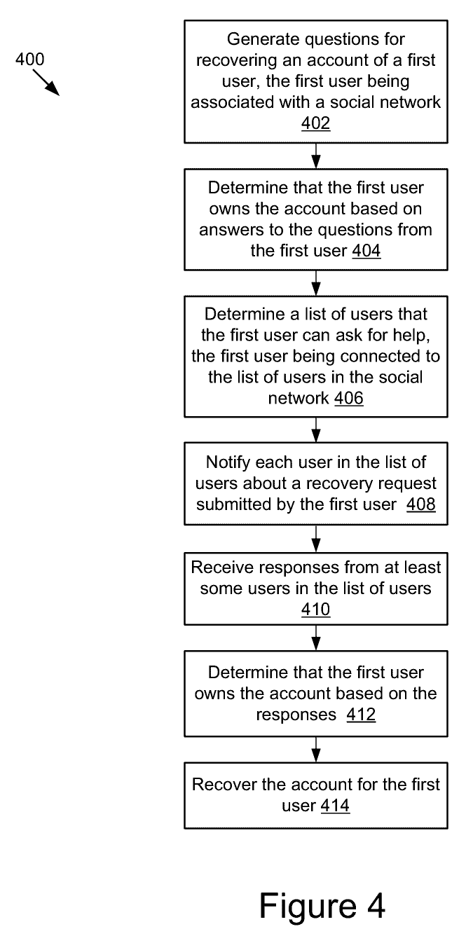

Referring now to FIGS. 4, 5A-5C and 6A-6D, various example methods of the specification will be described. FIG. 4 includes a flowchart 400 of an example method for using a recovery application 103 to verify that a user in a social network owns an account and recover the account for the user. The recovery application 103 includes a challenge module 205, a verification module 207, a helper module 209 and a recovery module 211. The challenge module 205 generates 402 questions for recovering an account of a first user. The first user is associated with a social network. The verification module 207 determines 404 that the first user owns the account based on answers to the questions from the first user. The verification module 207 determines that the first user has passed the first verification step and the first verification step completes. The helper module 209 determines 406 a list of users that the first user can ask for help (e.g., a help list). The first user is connected to the list of users in the social network. For example, the help module 209 determines whether to include a second user in the help list of the first user based on a communication history and a relationship history between the first user and the second user.

The helper module 209 notifies 408 each user in the help list about a recovery request submitted by the first user. The helper module 209 receives 410 responses from at least some users in the help list. The verification module 207 determines 412 that the first user owns the account based on the responses. The verification module 207 determines that the first user has passed the second verification step and the entire verification process completes. The method 400 moves to the final recovery step. Responsive to receiving a signal that the recovery request of the first user has been approved from the verification module 207, the recovery module 211 recovers 414 the account for the first user.

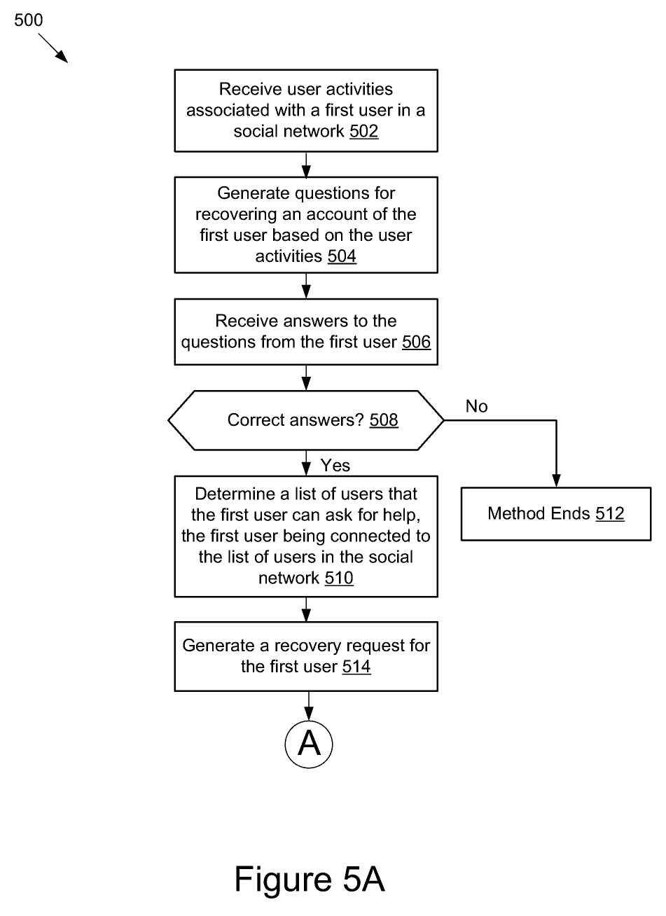

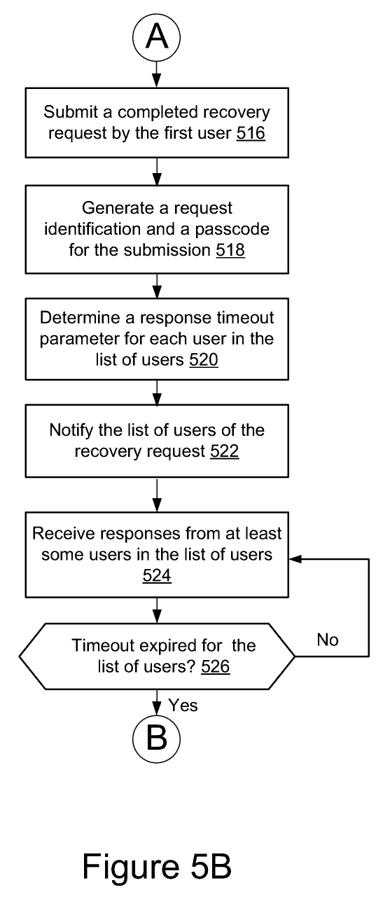

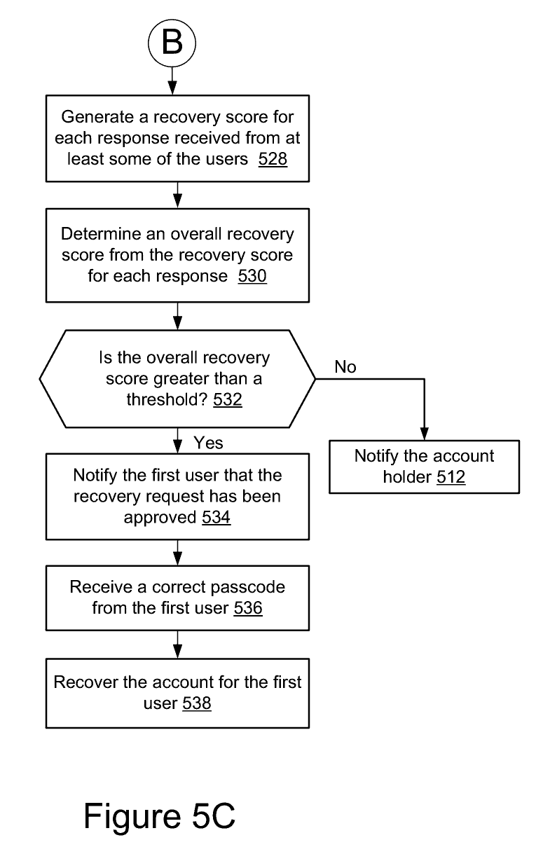

FIGS. 5A-5C include flowcharts 500 of an example method for using a recovery application 103 to verify that a user in a social network owns an account and recover the account for the user. The recovery application 103 includes a controller 201, a social network engine 203, a challenge module 205, a verification module 207, a helper module 209, a recovery module 211 and a user interface engine 213.

Referring now to FIG. 5A, the controller 201 receives 502 user activities associated with a first user in a social network. The controller 201 transmits the user activities to the challenge module 205. The challenge module 205 generates 504 questions for recovering an account of the first user based on the user activities. In some instances, the challenge module 205 processes the user activities to obtain user activity statistics and generates the questions based on the user activity statistics. In other instances, the challenge module 205 generates the questions based on pre-defined rules about the user activities. The controller 201 receives 506 answers to the questions from the first user and passes the answers to the verification module 207.

The verification module 207 determines 508 whether the answers are correct by comparing the user-provided answers to correct answers received from the challenge module 205 or data stored in the storage 105. In some instances, the verification module 207 determines that the answers are correct if each user-provided answer is consistent with the correct answers. In other instances, the verification module 207 determines that the user-provided answers are correct if at least N percent of the user-provided answers are consistent with the correct answers. In some instances, the verification module 207 specifies a fixed value for N. In other instances, the verification module 207 adjusts the value N based on a length of time elapsed determined from, for example, the answers and log-in details. If the verification module 207 determines that the user-provided answers are correct, the verification module 207 determines that the user has passed a first verification step and the method 500 moves to step 510. Otherwise, the method 500 ends 512.

A second verification step starts at step 510. The verification module 207 communicates with the helper module 209 to perform the second verification step to determine whether the user owns the account. In some instances, the helper module 209 includes a determining engine 301, a request module 303, a notification module 305, a response module 307 and a scoring engine 309.

The determining engine 301 determines 510 a list of users that the first user can ask for help (e.g., a help list). The first user is connected to the list of users in the social network. The determining engine 301 determines how many users and which users should be included in the help list. In some instances, the determining engine 301 determines a communication history between a second user in the social network and the first user and determines whether to include the second user in the help list based on the communication history. In some instances, the communication history includes a frequency, a recency and a number of communications between the first user and the second user over a length of time from a first interaction until a current time. In other instances, the determining engine 301 determines a relationship history between the first user and the second user and determines whether to include the second user in the help list of the first user based on the relationship history. In some instances, the relationship history includes a time that the first user has been connected with the second user in the social network and a social affinity score between the first user and the second user. In some other instances, the determining engine 301 also interacts with the first user to adjust the help list based on preferences of the first user.

The request module 303 generates 514 a recovery request for the first user. Referring now to FIG. 5B, the first user provides information to the request module 303, which submits 516 a completed recovery request. The request module 303 generates 518 a request ID and a passcode for the submission. In some instances, the request module 303 provides the request ID and passcode to the first user. In other instances, the request module 303 also transmits the request ID and the recovery request to the notification module 305.

The notification module 305 determines 520 a response timeout parameter for each user in the list of users. In some instances, the notification module 305 specifies a response timeout parameter for a second user in the list of users based on instructions received from the first user, a default or a time determined by the notification module 305 based on the second user's level of activity in the social network. The notification module 305 notifies 522 the list of users of the recovery request and asks each user to respond within the time interval specified by the response timeout parameter. In some instances, the notification includes a time that the first user lost control of the account, messages from the first user to each user in the list of users, a request ID to each user and instructions about when each user should respond the notification and how each user should respond the notification.

The response module 307 receives 524 responses from at least some users in the list of users. The response module 307 determines 526 whether the timeout has expired for the list of users based on the response timeout parameter received from the notification module 305. If the timeout has expired, the method 500 moves to step 526. Otherwise, the response module 307 continues to receive responses from at least some of the users. The response module 307 passes the responses received from at least some users in the list of users to the scoring engine 309.

Referring now to FIG. 5C, the scoring engine 309 generates 528 a recovery score for each response received from at least some of the users. In some instances, the scoring engine 309 determines a recovery score for a response from a second user in the help list of the first user based on the communication history and the relationship history between the first user and the second user. In other instances, the scoring engine 309 also determines whether the response from the second user is positive and correspondingly adjusts the recovery score for the response. The scoring engine 309 determines 530 an overall recovery score from the recovery score for each response. In some instances, the scoring engine 309 determines an overall score by averaging the recovery scores from each response. The scoring engine 309 sends the overall recovery score to the verification module 207 to determine whether the first user owns the account.

The verification module 207 determines 532 whether the overall recovery score is greater than a threshold. If the overall recovery score exceeds the threshold, the verification module 207 determines that the first user has passed the first and second verification steps and signals the recovery module 211 to recover the account for the user. The verification module 207 also notifies 534 the first user that the first user's recovery request has been approved. If the overall recovery score is below a threshold, in some instances the notification module 305 notifies the account holder that the recovery attempt failed. For example, the notification module 305 sends the notification to an email provided at the time of registration in case the recovery attempt was started by a hacker.

The recovery module 211 receives 536 a correct passcode from the first user and recovers 538 the account for the first user. In some instances, the recovery module 211 resets the user's credentials. For example, the recovery module 211 transmits an email with a link to the user that, when clicked, routes the user's browser to a webpage where the user is prompted to provide a new password and new security questions and answers. In some instances, the recovery module 211 receives a passcode from the first user, determines that the passcode is correct (e.g., by comparing with the request ID and passcode that are stored in the storage 105), recovers the account corresponding to the request ID based on the correct passcode and sends the account information to the first user. In some instances, where the recovery module 211 sends the account information to the first user, the information is time sensitive and if first user fails to access the account within a set period of time, the account is locked and the user repeats the recovery process again.

FIG. 6A is a graphic representation of an example user interface 600 generated by the user interface engine 213. In this example, the user interface 600 includes a first verification step for recovering an account of a first user in a social network. The user interface 600 includes questions 602 that can be used to recover the account of the first user. The challenge module 205 generates the questions 602 based on user activities associated with the account of the first user. The first user inputs the answers to the questions 602 via the user interface 600. The verification module 207 determines whether the answers are correct. If the verification module 207 determines that the answers are correct, the verification procedure for recovering the account of the first user moves to a second verification step as depicted in FIG. 6B.

FIG. 6B is a graphic representation of an example user interface 620 generated by the user interface engine 213. In this example, the user interface 620 includes a second verification step for recovering an account of a first user in a social network. The user interface 620 includes a recovery request form 622 that is generated by the request module 303. The recovery request form 622 includes a drop-down box 626, a button 636 and areas for providing input 624, 628, 630, 632 and 634. The request module 303 asks the first user to provide the information about when the first user lost control of the account in the area 624. The request module 303 receives a list of users that the first user may ask for help (e.g., a help list) from the determining engine 301 and communicates with the user interface engine 213 to include the list of users in the drop-down box 626. The first user can choose preferred users from the drop-down box 626 and have the chosen users listed in the area 628. The first user can also write down in the area 630 other users that are not included in the drop-down box 626 but the first user wants to ask for help. The determining engine 301 determines a final help list from the users listed in the areas 628 and 630. The first user can repeatedly adjust users in the areas 628 and 630 until the first user is satisfied with the final help list determined by the determining engine 301. The final help list is displayed in the area 632. Optionally, the first user can write a message to each user in the help list in the area 634. Once the first user completes the form, the first user submits the form by clicking the “submit” button 636. Responsive to receiving the completed request form, the request module 303 generates a request ID and a passcode for the submission of the request form.

FIG. 6C is a graphic representation of an example user interface 640 generated by the user interface engine 213. In this example, the user interface 660 includes the request ID 642 that is used to identify the recovery request of the first user and the passcode 644 that is associated with the recovery request.

FIG. 6D is a graphic representation of an example user interface 660 generated by the user interface engine 213. In this example, the user interface 660 includes a final recovery step for recovering an account of a first user in a social network. The verification module 207 verified that the first user, e.g., Melissa, owns the account and notified the recovery module 211 to reset the password and security questions for Melissa. The user interface engine 213 generates graphical data for displaying a request 662 for a new passcode and a request 664 for new security questions.

In the following description, for purposes of explanation, numerous specific details are set forth in order to provide a thorough understanding of the specification. It will be apparent, however, to one skilled in the art that the technology can be practiced without these specific details. In other instances, structures and devices are shown in block diagram form in order to avoid obscuring the description. For example, the specification is described in some instances above with reference to user interfaces and particular hardware. However, the description applies to any type of computing device that can receive data and commands, and any peripheral devices providing services.

Reference in the specification to “some instances” or “an instance” means that a particular feature, structure, or characteristic described in connection with the instance is included in at least some instances of the description. The appearances of the phrase “in some instances” in various places in the specification are not necessarily all referring to the same instance.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware embodiment, an entirely software embodiment or an embodiment containing both hardware and software elements. In a preferred embodiment, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

1. A computer-implemented method comprising:
receiving, with one or more computing devices, a request to initiate recovery of an account of a first user;
generating, with the one or more computing devices, a set of questions for recovering the account of the first user based on a user activity of the first user in a social network;
receiving, from the first user, with the one or more computing devices, one or more answers to the set of questions;
determining, with the one or more computing devices, an amount of correct answers based on the one or more answers to the set of questions;
determining a first threshold value of correct answers based on a time lapse between receiving the user activity of the first user in the social network and the one or more answers;
subsequent to receiving the request to initiate account recovery, determining, with the one or more computing devices, which of a plurality of users connected to the first user in the social network to include in a list of users that the first user can ask for help based on one or more of a communication history with the first user and a relationship history with the first user;
notifying, with the one or more computing devices, users in the list of users about a recovery request submitted by the first user;
receiving responses from at least some users in the list of users;
determining, with the one or more computing devices, that the first user owns the account based on whether the amount of correct answers from the first user exceeds the first threshold value of correct answers and determining whether any received response is positive; and
recovering, with the one or more computing devices, the account for the first user.

2. The method of claim 1, wherein determining which of the plurality of users connected to the first user in the social network to include in the list of users that the first user can ask for help includes:
determining a communication history between a second user in the social network and the first user, the communication history including at least one of a frequency of recent communications between the first user and the second user and an amount of communications between the first user and the second user over a total time period of interactions; and
wherein the second user is included in the list of users based on the communication history.

3. The method of claim 1, wherein determining which of the plurality of users connected to the first user in the social network to include in the list of users that the first user can ask for help includes:
determining a relationship history between a second user in the social network and the first user, the relationship history including at least a length of time that the first user has been connected with the second user in the social network; and
wherein the second user is included in the list of users based on the relationship history.

4. The method of claim 1, wherein determining whether any received response is positive comprises determining an overall recovery score from the responses, and determining whether the overall recovery score is greater than a second threshold.

5. The method of claim 1, further comprising determining a response timeout parameter for each user in the list of users, and wherein receiving the responses from the at least some users in the list of users is based on the response timeout parameter.

6. The method of claim 1, further comprising:
generating a recovery request form for the first user;
submitting the recovery request based on the first user having completed the recovery request form; and
generating a request identification and a passcode for the submission.

7. The method of claim 1, further comprising receiving a correct passcode from the first user, and wherein recovering the account for the first user is based on the correct passcode.

8. The method of claim 1, further comprising receiving user activities associated with the first user, and wherein generating the set of questions for recovering the account of the first user is based on the received user activities wherein the recovery request includes different messages from the first user to different users in the list.

9. The method of claim 1, wherein determining the list of users comprises adjusting the list of users according to preferences of the first user.

10. The method of claim 1, wherein notifying the list of users about the recovery request uses a communication means that is different from the communication means used for receiving the responses from the at least some users in the list of users.

11. A system comprising:
one or more processors, the one or more processors being configured to:
receive a request to initiate recovery of an account of a first user;
generate a set of questions for recovering the account of the first user based on a user activity of the first user in a social network;
receive, from the first user, one or more answers to the set of questions;
determine an amount of correct answers based on the one or more answers to the set of questions;
determine a first threshold value of correct answers based on a time lapse between receiving the user activity of the first user in the social network and the one or more answers;
subsequent to receiving the request to initiate account recovery, determine which of a plurality of users connected to the first user in the social network to include in a list of users that the first user can ask for help based on one or more of a communication history with the first user and a relationship history with the first user;
notify the list of users about a recovery request submitted by the first user;
receive responses from at least some users in the list of users;
determine that the first user owns the account based on whether the amount of correct answers from the first user exceeds the first threshold value of correct answers and determining whether any received response is positive; and
recover the account for the first user.

12. The system of claim 11, wherein, to determine which of the plurality of users connected to the first user in the social network to include in the list of users that the first user can ask for help, the one or more processors are further configured to:
determine a communication history between a second user in the social network and the first user, the communication history including at least one of a frequency of recent communications between the first user and the second user and an amount of communications between the first user and the second user over a total time period of interactions; and
wherein the second user is included in the list of users based on the communication history.

13. The system of claim 11, wherein, to determine which of the plurality of users connected to the first user in the social network to include in the list of users that the first user can ask for help, the one or more processors are further configured to:
determine a relationship history between a second user in the social network and the first user, the relationship history including at least a length of time that the first user has been connected with the second user in the social network; and
wherein the second user is included in the list of users based on the relationship history.

14. The system of claim 11, wherein determining whether any received response is positive comprises determining an overall recovery score from the responses, and determining whether the overall recovery score is greater than a second threshold recovery score.

15. The system of claim 11, wherein the one or more processors are further configured to determine a response timeout parameter for each user in the list of users, and wherein receiving the responses from the at least some users in the list of users is based on the response timeout parameter.

16. A computer program product comprising a non-transitory computer usable medium including a computer readable program, wherein the computer readable program when executed on a computer causes the computer to:
receive a request to initiate recovery of an account of a first user;
generate a set of questions for recovering the account of the first user based on a user activity of the first user in a social network;
receive, from the first user, one or more answers to the set of questions;
determine an amount of correct answers based on the one or more answers to the set of questions;
determine a first threshold value of correct answers based on a time lapse between receiving the user activity of the first user in the social network and the one or more answers;
subsequent to receiving the request to initiate account recovery, determine which of a plurality of users connected to the first user in the social network to include in a list of users that the first user can ask for help based on one or more of a communication history with the first user and a relationship history with the first user;
notify the list of users about a recovery request submitted by the first user;
receive responses from at least some users in the list of users;
determine that the first user owns the account based on whether the amount of correct answers from the first user exceeds the first threshold value of correct answers and determining whether any received response is positive; and
recover the account for the first user.

17. The computer program product of claim 16, wherein, to determine which of the plurality of users connected to the first user in the social network to include in the list of users that the first user can ask for help, the computer readable program when executed on the computer further causes the computer to:
determine a communication history between a second user in the social network and the first user, the communication history including at least one of a frequency of recent communications between the first user and the second user and an amount of communications between the first user and the second user over a total time period of interactions; and
wherein the second user is included in the list of users based on the communication history.

18. The computer program product of claim 16, wherein, to determine which of the plurality of users connected to the first user in the social network to include in the list of users that the first user can ask for help, the computer readable program when executed on the computer further causes the computer to:
determine a relationship history between a second user in the social network and the first user, the relationship history including at least a length of time that the first user has been connected with the second user in the social network; and
wherein the second user is included in the list of users based on the relationship history.

19. The computer program product of claim 16, wherein determining whether any received response is positive comprises determining an overall recovery score from the responses, and wherein determining whether the overall recovery score is greater than a second threshold recovery score.

20. The computer program product of claim 16, wherein the computer readable program when executed on the computer further causes the computer to determine a response timeout parameter for each user in the list of users, and wherein receiving the responses from the at least some users in the list of users is based on the response timeout parameter.
